(19) United States
(12) Patent Application Publication
(10) Pub. No.: US 2026/0027720 A1
(43) Pub. Date: Jan. 29, 2026

(54) REAL-TIME FLORA DETECTION AND GEOMETRIC TRAITS EXTRACTION USING A MOBILE ROBOT

(71) Applicant: THE REGENTS OF THE UNIVERSITY OF CALIFORNIA, Oakland, CA (US)

(72) Inventors: Konstantinos Karydis, Laguna Beach, CA (US); Dimitrios Chatziparaschis, Riverside, CA (US)

(73) Assignee: THE REGENTS OF THE UNIVERSITY OF CALIFORNIA, Oakland, CA (US)

(21) Appl. No.: 19/280,737

(22) Filed: Jul. 25, 2025

Related U.S. Application Data
(60) Provisional application No. 63/675,525, filed on Jul. 25, 2024.

(51) Int. Cl. B25J 9/16; B25J 5/00; B25J 11/00; B25J 19/02

(52) U.S. Cl. CPC B25J 9/1679; B25J 5/007; B25J 9/161; B25J 11/00; B25J 19/023

(57) ABSTRACT

A mobile robot is programmed to travel through an agricultural area, such as an orchard of trees. The robot includes a camera for collecting two-dimensional image data associated with flora items in the agricultural area, and a light detection and ranging (LiDAR) system for detecting signals and collecting data indicative of a three-dimensional coordinate system of the agricultural area. The robot also includes a three-dimensional detection module programmed for generating clusters representative of flora items detected in the agricultural area, and for fusing portions of image data collected by the camera, data collected by the LiDAR system, and cluster data associated with the detected flora item. A correspondence module can be provided for matching detected flora items to a map of landmark flora item references.

### CROSS REFERENCE TO RELATED APPLICATIONS

This application claims the benefit of U.S. Provisional Application No. 63/675,525, filed Jul. 25, 2024, which is incorporated by reference in its entirety.

### STATEMENT REGARDING FEDERALLY SPONSORED RESEARCH

This invention was made with federal government support under National Science Foundation Contract Nos. 1901379 and 2046270; United States Department of Agriculture National Institute of Food and Agriculture (USDA-NIFA) Contract No. 2021-67022-33453; and Office of Naval Research (ONR) Contract Nos. N00014-18-1-2252 and N00014-19-1-2264. The federal government may have certain rights in the invention.

### FIELD OF THE INVENTION

In various embodiments, the present invention generally relates to robotically-enabled tools, devices, and methods. In certain embodiments, the invention more particularly relates to robotically-enabled tools, devices, and methods for detecting the presence of flora such as trees in an orchard and determining characteristics of the detected flora.

### INTRODUCTION

Real-time tree crop monitoring is important in agriculture because it allows growers to make informed decisions about management practices, address potential issues promptly, and ultimately optimize crop yields and profitability. Growth rates, yields, and fruit quality can vary significantly on a tree-by-tree basis in commercial orchards due to the spatiotemporal variability of environmental factors such as soil conditions and microclimate, as well as management practices (e.g., non-uniform irrigation distribution) and their interaction with individual tree genetic variability. Unfortunately, it is impractical to directly measure the status (e.g., leaf water potential, fruit quantity, and quality) over time for every single tree.

In certain conventional practices, Unmanned Aerial Vehicles (UAVs) have been deployed in agricultural areas such as orchards to acquire information from above and map area characteristics. Yet, the accuracy of these approaches is highly dependent on the resolution of the sensors employed by the UAV and its flight altitude. Moreover, UAVs are clearly not practical for collecting data from under or on the sides of tree canopies. In other practices, mobile robots have been used for in-field near-ground sensing to collect various types of data about tree geometric traits and health markers. In studies involving robotic proximal sensing, trees are often used as landmarks for localization.

In most cases, tree detection is based on trunk recognition since the trunk can represent a relatively permanent, unmoving landmark in the dynamic environment. Unfortunately, tree trunks may not always be directly visible in the scene, as their visibility can be drastically affected by dense, dynamic, and verdant environmental conditions. Other approaches have suggested trained detectors for trunk or other tree part detection to improve detection robustness. However, the performance of these approaches highly depends on additional computational resources, precise training, and the generalizability of the method to be robust in different kinds of agricultural environments.

What are needed, therefore, are improved robotically-enabled techniques, tools and devices that can address the above-described issues with conventional practices by gathering tree-by-tree data in an efficient and scalable manner. Such enhanced technology is needed to more effectively and efficiently detect the presence of flora in an agricultural area (e.g., trees in an orchard) and determine characteristics of the detected flora.

### SUMMARY

In accordance with an aspect, a robot programmed to travel through at least a portion of an agricultural area, the robot comprising: a drive system configured for moving the robot through the agricultural area; a camera for collecting two-dimensional image data associated with flora items in the agricultural area; a light detection and ranging (LiDAR) system comprising at least one sensor programmed for detecting signals and collecting data indicative of a three-dimensional coordinate system of the agricultural area; a computer processor programmed for executing multiple computer-implemented modules of the robot; a three-dimensional detection module programmed for: generating, by the processor, at least one cluster representative of a flora item detected in the agricultural area, and fusing, by the processor, at least portions of image data collected by the camera, data collected by the LiDAR system, and cluster data associated with the detected flora item; and a correspondence module programmed for matching, by the processor, the detected flora item to a map comprising at least one landmark flora item reference.

In accordance with another aspect, a method for detecting flora in an agricultural area, the method comprising: programming a robot to travel through at least a portion of the agricultural area, the robot including a drive system configured for moving the robot through the agricultural area, a camera for collecting two-dimensional image data associated with flora items in the agricultural area, and a light detection and ranging (LiDAR) system including at least one sensor programmed for detecting signals and collecting data indicative of a three-dimensional coordinate system of the agricultural area; generating, by a processor, at least one cluster representative of a flora item detected in the agricultural area with a three-dimensional detection module; fusing, by the processor, at least portions of image data collected by the camera, data collected by the LiDAR system, and cluster data associated with the detected flora item with the three-dimensional detection module; and matching, by the processor, the detected flora item to a map comprising at least one landmark flora item reference with a correspondence module programmed for matching.

### BRIEF DESCRIPTION OF THE DRAWINGS

FIG. 1(a) is an illustration of a Clearpath Jackal equipped with a Velodyne VLP-16 LiDAR and a MAPIR Survey3N RGN camera during field experiments.

FIG. 1(b) is an illustration of a designed simulation world in Gazebo along the simulated Jackal mobile robot, and wherein the world model contains a 2×3 tree grid of 3 orange and 3 lemon trees placed at 5 m width×5 m length relative distance from each other.

FIG. 2(a) is a snapshot from robot operation in the orchard showing RGN raw imagery data.

FIG. 2(b) is a snapshot from robot operation in the orchard showing corresponding binary thresholded NDVI frame with projected 3D LiDAR data colorized based on z-level value.

FIG. 3 is a system diagram of the proposed 2D-3D fusion system with main sub-components, along with the positioning node, the field map node, and the raw sensory input streams, and wherein the solid lines indicate the inner connectivity of the components and the dotted arrows the information exchange between the developed nodes.

FIG. 4(a) is an illustration in height estimation, and wherein the robot senses a change on top ring_id detection of the cluster Ci and thus registers the height value with respect to {base_footprint}.

FIG. 4(b) is an illustration in width estimation, and wherein the robot computes the width value for each of the 10 z-slices of the clusters and stores the maximum value.

FIGS. 5(a)-5(c) are panoramic views of the simulated tests wherein FIG. 5(a) is straight-line, FIG. 5(b) is an N-type, and FIG. 5(c) is an S-type robot trajectories on the 5 m width×5 m length tree grid setup. Along with the sampled and decreasingly transparent (with respect to time) robot poses, there is a colorized illustration of the detected tree candidates' p_{centroid} points, which are projected on the UTM x-y plane to demonstrate their distribution around the groundtruth GT tree positions.

FIG. 6(a)-FIG. 6(c) are snapshot from the N-type field experiment in the orchard, where FIG. 5(a) is tree detection status along with detected Cₖ tree clusters. The image depicts information stats of each detected and matched cluster during that time (green rings are used for trees' width estimation, and red points are part of each cluster), FIG. 5(b) is the corresponding RGN frame along with the projected LiDAR information and depicted tree information, and FIG. 6(c) is a closer third-person view of the Jackal in RViz closely matching the RGN frame.

FIGS. 7-15 illustrate different aspects of examples of experimental testing involving a mobile robot configured and programmed in accordance with various embodiments of the invention described herein

FIG. 16 is Algorithm 1, Tree Detection, Identification and Characteristics Estimation in accordance with an exemplary embodiment.

FIG. 17 is Table 1, which illustrates Field Experiment Results in accordance with an exemplary embodiment.

FIG. 18 is a flow chart illustrating a method for detecting flora in an agricultural area in accordance with an embodiment.

FIG. 19 illustrates a representative computer system in which embodiments of the present disclosure, or portions thereof, may be implemented as computer-readable code executed on hardware.

### DETAILED DESCRIPTION

In developing various embodiments of the invention described herein, the inventors have recognized that by using a mobile robot 100 equipped with data fusion capabilities for data received from multiple ground-based (and remote) sensors 110, 120, the status of an agricultural area 200 (e.g., an orchard of trees) can be analyzed in substantially real-time. The techniques described herein may involve proximal sensing of plant geometric and vegetation index markers by using a semi-autonomous ground mobile robot in large-scale agricultural or field environments.

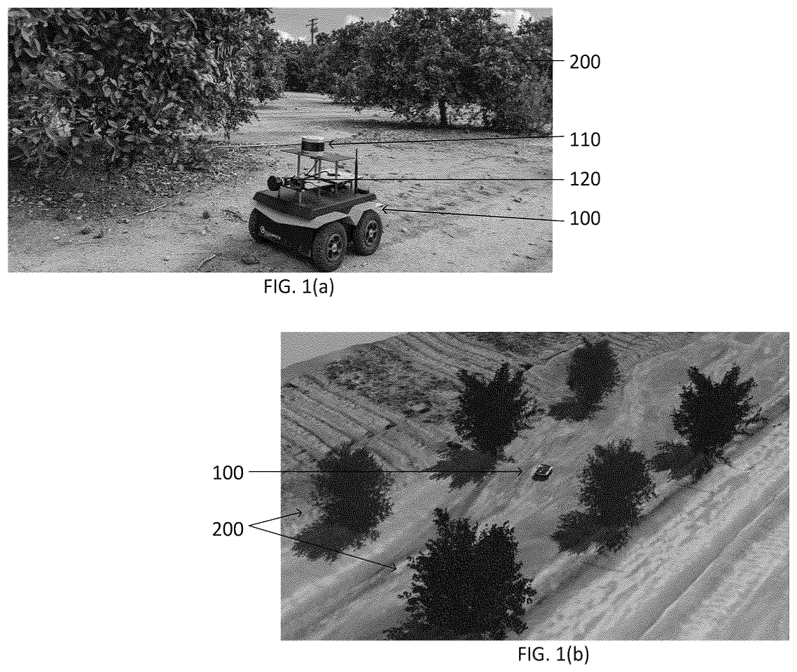

In various embodiments, as shown in FIG. 1(a), a mobile robot 100 can be equipped with a three-dimensional (3D) light detection and ranging (LiDAR) system 110 with sensors, and a two-dimensional (2D) RGN (Red-Green-NIR) camera module 120. The robot 100 can be programmed to perform real-time fusion of different sensor modalities with one or more algorithms to obtain and identify the surrounding tree candidates 200, extract their geometric or spatial-based characteristics (e.g., height and width) and vegetation-based characteristics or vegetation index information, and correlate the detected landmarks with globally georeferenced trees to update their status in a surveying map, for example. Spatial information derived from trees in real-time can be fused with vegetation-based characteristics and correlated with known landmark references on a map, for example. Tree candidates can be extracted and characterized without relying exclusively on any specific part of the tree body. The algorithm can fuse domain-specific (RGN) 2D image data with 3D LiDAR-based point clouds. This data fusion approach can be used to acquire the observed tree candidates in the field of view of the mobile robot in real-time. Also, multi-variate criteria can be applied for optimal tree cluster matching in connection with the LiDAR coordinate system, for example.

Embodiments of the invention may use proximal sensing, which can be defined as in-situ (on-site) data collection in the field typically performed with ground-based robots. Computation of geometric and vegetation index characteristics of each tree can be processed, and updates can be made, in real-time as the robot is traveling through an agricultural area. These techniques can help to obtain canopy density and field health status, for example, which may be used as a scalable diagnostics tool by the grower or an agronomist to make informed decisions about the applied crop management practices. The system can be autonomous-ready, for example, by employing Global Navigation Satellite System (GNSS) and waypoint navigation, to help stimulate further agricultural robotics research. The system can also be integrated directly into existing commercial semi-autonomous or autonomous agricultural vehicles (e.g., smart tractors) for various applications.

In various embodiments, the invention provides an algorithmic framework to perform real-time and on-the-go detection of trees and key geometric characteristics (e.g., width and height) with wheeled mobile robots 100 in the field. One aspect of the methodology is based on the fusion of 2D domain-specific data (normalized difference vegetation index or “NDVI”) acquired via a red-green-near-infrared “RGN” camera and 3D LiDAR point clouds, and via a customized tree landmark association and parameter estimation algorithm. Through data fusion from multiple ground (and remote) sensors, automated sampling methods can be applied and new models can be developed to assess orchard status on-the-go.

In certain aspects, the system features a multi-modal and entropy-based landmark correspondences approach integrated into an underlying Kalman filter system to recognize the surrounding trees and jointly estimate their spatial and vegetation-based characteristics. Realistic simulated tests can be used to evaluate the algorithm's behavior in a variety of settings. Physical experiments in agricultural fields can be used to help validate the method's efficacy in acquiring accurate by-tree information on-the-go and in real-time by employing onboard computational and sensing resources. The system has been deployed and tested experimentally in the field under real-world conditions (e.g., significant wind gusts and frequent ambient light variations).

The system incorporates an approach based on both 2D and 3D sensing modalities to obtain real-time tree correlations and match them with globally georeferenced trees to update their status in the surveying map. A real-time LiDAR-camera fusion algorithm can be implemented to obtain accurately the surrounding tree geometric traits and geo-reference obtained information on a global map. A multivariate, entropy-based correspondences algorithm can be integrated into an underlying Kalman Filter, for robust 3D tree cluster matching for localization. Also, robot-assisted proximal RGN sensing from the ground can be used for enabling integration of domain-specific vegetation data for active landmark detection outdoors.

In one example, a Clearpath Jackal wheeled mobile robot 100 can be used (see FIG. 1(a)). The robot has body dimensions of 50.8 cm×43.2 cm×25.4 cm and weighs 17 kg. It features an NVIDIA Xavier AGX internal PC, a GPS receiver, an integrated IMU sensor, and two wheel encoders. It is equipped with a 3D LiDAR sensor 110 (Velodyne VLP-16) and an RGN camera 120 (MAPIR Survey3N); both are affixed to the robot's chassis. The publication rate of the LiDAR sensor was set to 10 Hz thus providing up to 300,000 points per second. Each point in the point cloud P⊆ [symbol] ³ also holds information about the 3D LiDAR ring id that was detected.

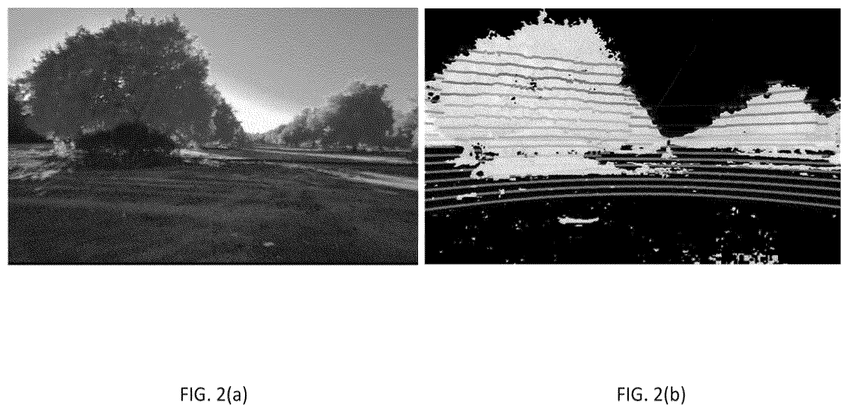

RGN Camera. The main purpose of the RGN camera is the inclusion of Near Infrared (NIR) band in imaging. Given readings in the red and green channels of the sensor, NIR provides critical information used to compute the Normalized Difference Vegetation Index (NDVI), defined as NDVI=(NIR−Red)/(NIR+Red). NDVI can help pinpoint and quantify areas with lower chlorophyll status and vegetation health, since it is a ratio of near-infrared radiation (highly reflected by vegetation) and red light (mainly absorbed by vegetation). The camera can provide 30 fps of 720p RGN feed through a USB connection directly to the onboard computer. FIG. 2(a) shows a snapshot of the raw RGN imagery information captured in the field. During field survey, reflectance calibration ground target package (V2) can be used to regulate the minimum and maximum reflectance values and obtain NDVI readings in the low-high normalized health range of [−1.0, 1.0], respectively. Also, the camera can be calibrated to acquire intrinsic properties and lens distortion coefficients used for 3D LiDAR points' projection on the RGN image plane, wherein q₀∈0⊆ [symbol] are the 3D points in the camera's coordinate system and q_{x,y}∈Π [symbol] is their representation on the image plane on pixel position (x, y).

LIDAR-RGN Camera Extrinsic Calibration. In a LIDAR-camera fused detection approach the relative pose of the two sensors (i.e., extrinsic calibration) can be defined. To do so, a scene-based calibration approach can be employed to estimate the extrinsic parameters and obtain the LiDAR-to-camera frame transformation matrix

$${}_{P}^{\prod } T$$

∈SE(3). FIG. 2(b) shows projected LiDAR points on the NDVI frame.

Positioning in Global and Local Frames. To correlate detected tree candidates in the environment with ground truth tree landmarks, robot localization software from the ROS navigation stack can be employed. The localization software uses the robot's GNSS data, the earth-referenced heading, and odometry information to generate a Cartesian datum in the Universal Transverse Mercator (UTM) coordinate system. This aligns with experiments described herein which assume access to tree field geomaps and the robot's initial pose.

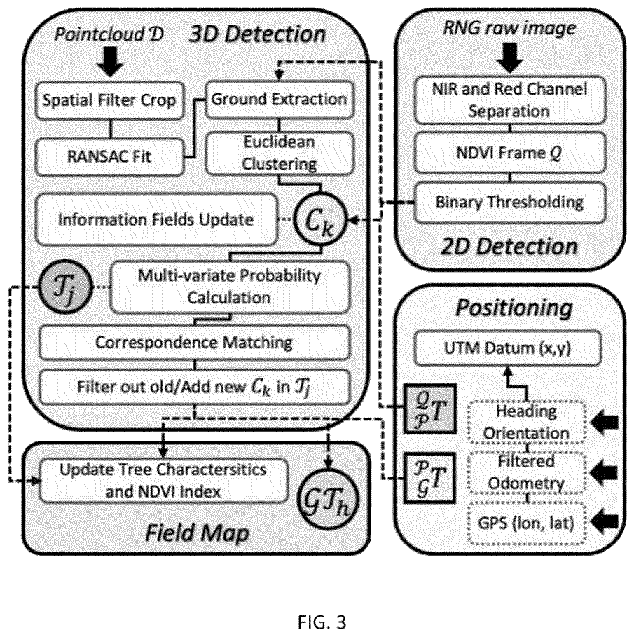

FIG. 3 schematically illustrates a system and an overall process flow of one example of the framework described herein. The main parts of the framework include multi-modal data fusion, correspondence matching, and estimation of desired traits (e.g., tree height and width). With regard to 2D and 3D data fusion and tree detection, one goal of the algorithm is to detect and recognize M tree candidates, Tⱼ with j∈[1, M], in a captured point cloud P, and to match them with N global georeferenced trees on the field, GTₕ with h∈[1, N], to update their width and height information, for example, in real-time and on-the-go.

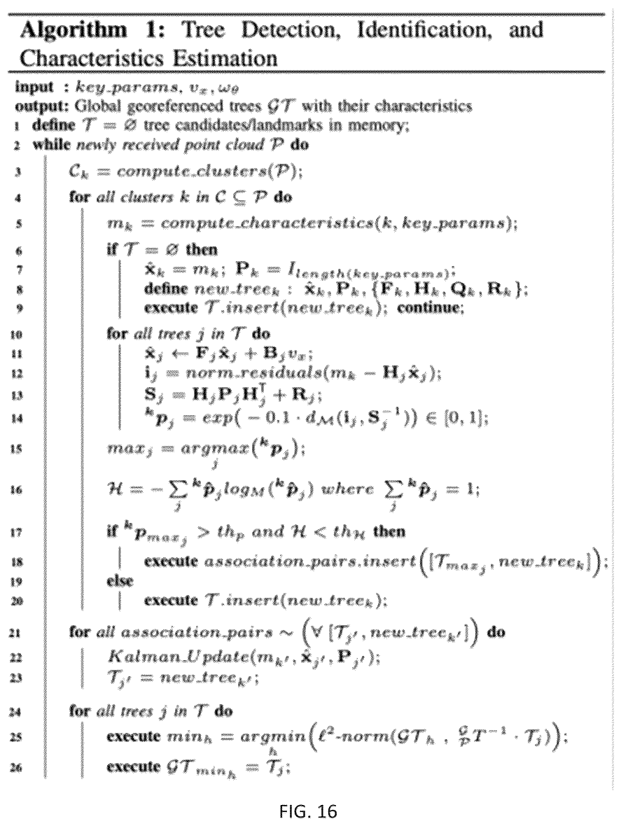

As an initial step in this example, the three channels in the RGN camera are split to compute the points' NDVI value v_{ndvi}∈ [symbol] . Binary thresholding is applied to the computed single-channel NDVI frame to segment the vegetation areas (selected values were set in the range q_{x,y}∈(−0.3,1.0] following calibration testing in the field). At the same time, spatial filtering and Random Sample Consensus (RANSAC) fit can be applied to the received point cloud P along with an additional check of point projection on Π to remove points that belong on the ground surface. The remaining point cloud is downsampled and Euclidean Clustering can be applied to discretize and obtain appearing clusters in the P space, all while preserving the closest v_{ndvi} values. The process takes place in the function compute_clusters in line 3 of Algorithm 1 (FIG. 16).

For each cluster Cₖ={p∈P; v_{ndvi}}∈ [symbol] ⁴, the system computes the centroid point p_{ct}∈ [symbol] ³, the total number of points numₚₜ∈N, and the average NDVI value v̅_{ndvi}∈ [symbol] as the main correspondence matching characteristics. These features can be used for the state estimation of each landmark Tⱼ.2. It is also possible to consider additional attributes, e.g., convex hull area and volume of the points included in each Cₖ. This has limited impact on the pipeline's runtime considering the small Cₖ size while increasing system capabilities. This provides \hat{x}ₖ=[p_{ct}, numₚₜ, v̅_{ndvi}]∈ [symbol] ^{5×1} and Pₖ=I₅, where \hat{x}ₖ is the state estimate and Pₖ the estimate covariance. Lines 6 to 9, indicate the initialization of the first tree clusters in memory, as individual Kalman Filter estimates with the internal models {Fₖ, Hₖ, Qₖ}=I₅ and Rₖ=0.1·I₅.

Tree Landmarks Correspondence Matching. To achieve robust landmark prediction and association while surveying, a probability calculation approach can be used during the Kalman innovation step. The main task is to associate newly retrieved clusters Cₖ with landmarks Tⱼ stored in memory. The control-input matrix Bⱼ=[cos(θ)Δt 0; sin(θ)Δt 0] can be used in the prediction step line (11), and then obtain the residual innovation iⱼ for each tree Tⱼ in memory and normalize it to reflect the percentage change (line 12).

Then, the Mahalanobis distance d_{M} can be calculated to determine the divergence of the innovation (error) residual from zero. The exponential distribution function is used to transform distance values into a probability ^{k}pⱼ∈[0,1] (line 14). Once the tree association probabilities for each cluster have been computed, the cluster with the closest match and index is obtained as maxⱼ. To increase tree association robustness, the entropy [symbol] can also be computed across the normalized probabilities of all landmark pairs (see line 16 of Algorithm 1). This metric can quantify the level of uncertainty in landmark-to-cluster associations and help decide if a new landmark instance that matches the characteristics of a specific Cₖ should be created and added in memory. When the cluster complies with both probability and entropy criteria, it is considered a match with Tₘₐₓ_{ⱼ} (scc Algorithm 1, lines 17-18). The cut-off values for these two criteria may need to be adjusted as the application domain varies; in the present example, they have been determined empirically via preliminary testing (e.g., thₚ:=0.5, t [symbol] =0.8). Given the computed pairs (Tⱼ,Cₖ), matching duplicates can be discarded (e.g., as potential instances of equal probability), and the system can proceed with updating characteristics of interest (e.g., tree width and height; see below), state estimates, and covariance matrices (see lines 21-23 in Algorithm 1).

Since each cluster is expressed in the LiDAR frame P, the inverse of the transformation matrix

$${}_{P}^{G} T$$

can be used to transform each Tⱼ to the global Cartesian frame created by and evaluated the present algorithm's real-time performance and the UTM datum. Thus, the closest GTₕ candidate can be found by computing the [symbol] ²-norm in x-y plane (line 25), and as (Tⱼ, GTn) pairs are obtained and the corresponding global georeferenced trees are updated (line 26). To handle the event of operating in GNSS-denied areas, the system can preserve and update the local Tⱼ map during navigation, associating it with GTₕ during periods with minimal GNSS interference.

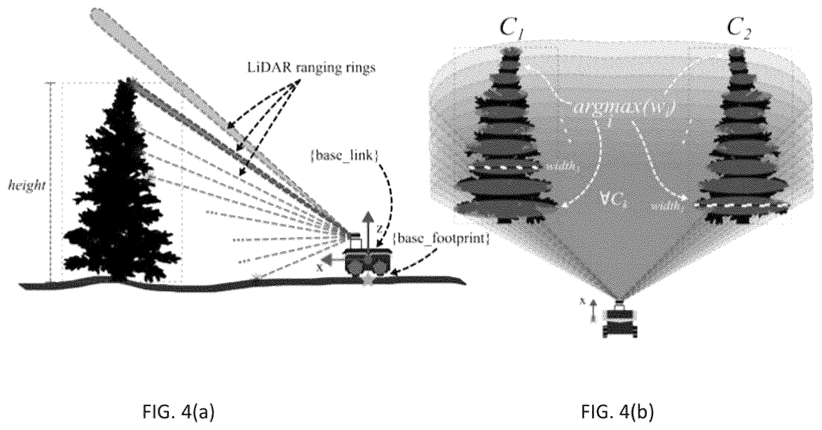

Tree Characteristics Estimation: Height and Width. As the robot moves in the field, the LiDAR sensor may not always fully cover the tree trunk and crown. As illustrated schematically in FIG. 4(a), some LiDAR rays may cast on the tree's crown and others may cast away from the tree. However, since the LiDAR has a fixed vertical angular resolution of 2°, the sensor may raycast on the tree crown's topmost part as the robot moves and hence provide information about the tree's height. Thus, to estimate the height of the tree, each tree candidate's Tⱼ top point's ring id detection can be kept with prior detections and the tree height can be captured on the change of the top-ranging ring. The estimated height can be refined each time a tree candidate is detected; and the maximum value can be retained. For width estimation, each cluster can be divided into a constant number of increasing z-level point cloud batches (e.g., 10 batches) in space P, and the farthest 3D point pairs can be determined. Given these pairs in different z-levels, the [symbol] ²-norm can be calculated to find the maximum value, which can be pinpointed as the tree's diameter (i.e., width). As the robot navigates, the width of a tree candidate can be recomputed for each new point cloud P received, and the maximum value can be retained as the width of the tree candidate. FIG. 4(b) schematically illustrates the width estimation procedure.

The present system and algorithm were experimentally tested in both realistic simulated and real-world field survey experiments. In the simulation study, the test involved a survey on a 2×3 citrus tree grid setup and assessed algorithm performance based on (1) using different tree placement densities, and (2) following different paths in the field. For the real-world field experiments, the robot was deployed in an orange tree grove to evaluate algorithm real-time performance and accuracy by following different survey paths in the orchard. To further enhance the evaluation results, tests were performed on a larger citrus grove from the CitrusFarm open dataset. Ground truth information was obtained directly from the 3D tree models in the simulation cases, and from a prior synthetic map created for the real-world cases.

Evaluation in Simulated Tests. Simulated tests were conducted within the Gazebo simulator. The mobile robot model was modified to integrate the actual sensors' configuration and noise models. To increase the fidelity of the robot's traversability with respect to the real world, a custom 3D world was generated with aerial imagery data of a citrus field at UCR's Agricultural Experimental Station (AES; 33° 58′ 3.2592″ N, 117°20′ 7.0296″W) with the Agisoft Metashape software. Various realistic citrus (lemon and orange) tree instances were created by the Helios library and integrated into the simulated world. Using different tree placement densities: three different world models were generated by having the citrus trees 4 m, 5 m, and 6 m away from their neighboring trees. These grids were denoted {4, 5, 6} m width×{4, 5, 6} m length, respectively. The instance of 5 m width×5 m length is depicted in FIG. 1(b). These selections were made so as to be consistent with tree placement in commercial citrus orchards. From an algorithmic standpoint, this enabled examination of its performance in both sparsely-planted and densely-planted orchards. Table I presents the evaluation results of five independent trials in each of the three tree-grid cases.

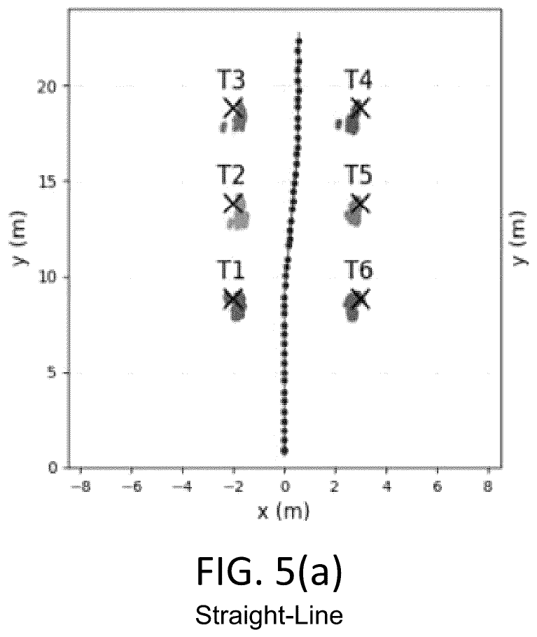

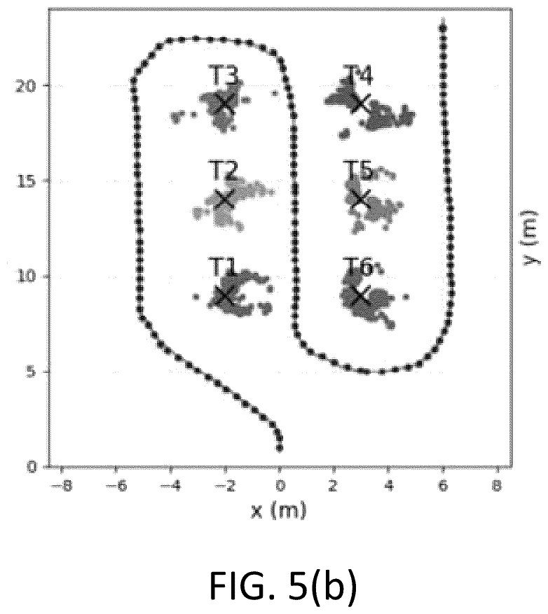

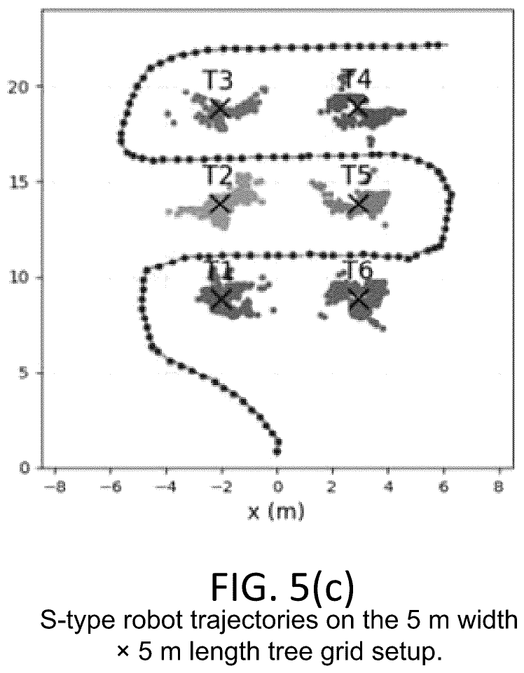

To perform the simulated surveys, a goal waypoint was provided in all grid cases for the robot to follow. The goal was set 23 m ahead from the origin along the longer side of the field (see FIG. 5(a)). The robot does not stop at any point unless it has reached the goal. Runtime comparisons between the present method and RPH indicated a twofold time increase in tree detection in the latter case. RPH requires an average of 0.53 sec for detecting the clusters in point clouds of 27-30K points, whereas the present method has an average of 0.22 sec detection runtime in the same point clouds and can provide up to two times more tree detections in the same time frame. One of the main reasons causing delays in RPH seems to be the PCA step for locating clusters with z-axis divergence. Tree detection accuracy was similar to the present S-case as both methods use Euclidean clustering, as a basis, to form the clusters Cₖ.

Results from tree characteristics extraction (rows of PathType: “Straight” in Table I) show that the present algorithm enables the robot to perform both tree width and height estimation accurately in all cases. The maximum Mean Absolute Percentage (MAP) errors observed were 12.1% and 14.7% for width and height estimations, respectively, over all tree configurations. Since the robot starts from point (0, 0), it captures more observations (greater view) of the front row, and thus achieved 2%-5% of absolute percentage error less compared to those for the middle and back row. On the other hand, height estimation error decreased by 3% in more sparsely-planted fields, namely cases of 5×5 and 6×6 because of the broader field of view of the robot. The RPH method had up to 3% higher average MAP error in both width and height estimation, which can be linked to the slower runtime and thus a smaller number of tree observations. In the present approach, comparably higher errors (on average) can be linked to the fact that the algorithm is using ranging information from the topmost part of a tree to estimate its height, but the former may be assessed multiple times during robot traversal thus including measurement variability.

Following different paths in the field: the second set of simulated tests examined the behavior of the algorithm as the followed path may vary. Using the 5×5 tree placement grid, the present algorithm's performance was tested in more complex path types, namely N-type and S-type paths, in comparison to the aforementioned straight-line findings (first three rows of Table I). Sample N-type and S-type paths are shown in FIGS. 5(a)-5(c). From the reported results, it was observed that the present algorithm scores 4.3% and 8.3% of MAP error in width estimation and 8.4% and 3.1% of MAP error in height estimation for S-type and N-type trajectories, respectively. One of the main factors contributing to the difference in accuracy compared with the straight case is that the robot performs closer maneuvers inside the field. Similar performance is also notable in the RPH case, with an increase up to 8% and 5% of average MAP error in width and height estimation, respectively. In both systems, N-type surveys led to better estimations of the height level of the trees due to the longer straight lines within the field, while S-type surveys helped with a better estimation of the tree width due to the multiple traverses closer to the tree rows. In all, despite the different maneuvers in the field, the present algorithm had an average of 5.3% in MAP error in both of these cases, demonstrating its robustness in width and height estimation.

Evaluation and Validation in Field Experiments. The algorithm was evaluated to validate its efficacy in field experiments. A real survey was performed in a citrus tree grove at UCR AES. This test focused on a 2×3 tree grid part of the selected field (to be consistent with the simulation test setup). This grid featured 6.5 m width×7 m length tree placement, which is a setup not included in simulated tests. On the day of the experiment, the reported wind speed was at 16 km/h, with gusts up to 40 km/h.

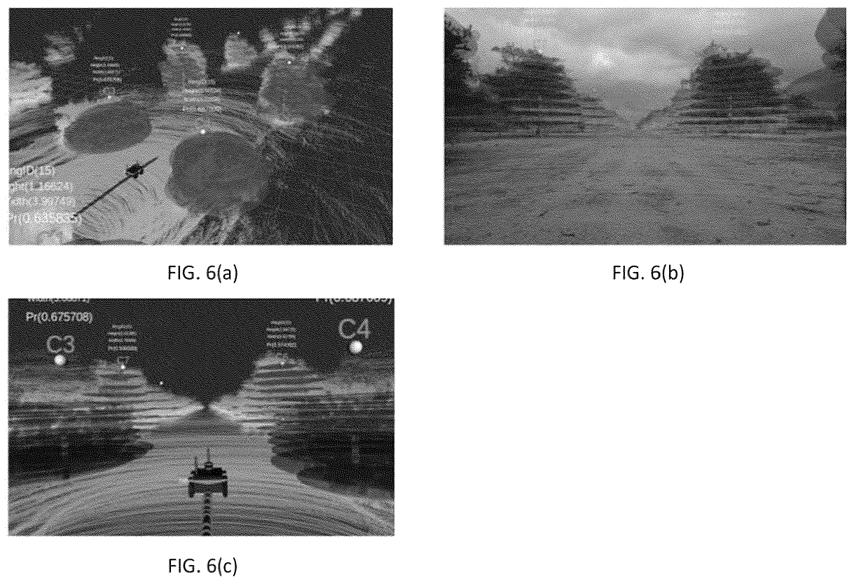

Quantitative results for all cases are provided in Table I, and FIGS. 6(a)-6(c) visually illustrate instances of the algorithm's behavior. Despite the windy conditions in the field, the robot scored a maximum of 16.6% and 15.2% MAP error in tree width and height estimation, respectively, over all trajectory types. Consistent with simulation findings, longer in length and more straight paths led to better results as observed by the straight case scoring on average 3% and 4% less MAP errors, compared with S and N cases, respectively. Similarly, on the RPH case, the height estimation results appear to be similar in all cases, averaging at 2.5% MAP more than ours. However, in width estimation on RPH case, the N case was the noisiest, as the windy conditions along with the restricted runtime of the algorithm were not ideal for width estimation (as seen also in the simulated experiments), by scoring 10% of additional average MAP error. Overall, the present algorithm gave less than 17% MAP error of geometric trait estimation, over all tested cases, even at challenging field conditions (high wind and diverse ambient light variations). Additionally, in these cases, the robot collected average NDVI measurements from each tree.

For the cases of the N and S-typed trajectories (since they cover all the sides of the inspected trees), the test observed resulting scores of 80% of an average relative distance, by noting +0.55, +0.61, and +0.62 of an average NDVI index, for the front, middle, and back row of the inspected trees. To further support the evaluation step, the present system was tested on a multi-modal dataset from CitrusFarm, that includes RGN and 3D LiDAR modalities collected by a mobile robot. A survey path was used with N-type trajectory, in a 5×3 citrus tree grove of 29×21 m² area size. With reference to Table I, the present system performs with a maximum MAP error at 12.7% at width estimation and 9.9% at height estimation, respectively, showcasing its scalability into larger fields. There was no reported wind in the dataset of CitrusFarm as it was captured on a sunny day, which contributes to the observed improvements on average MAP errors. The RPH approach showcased an additional 3.4% of average MAP error in both estimation cases.

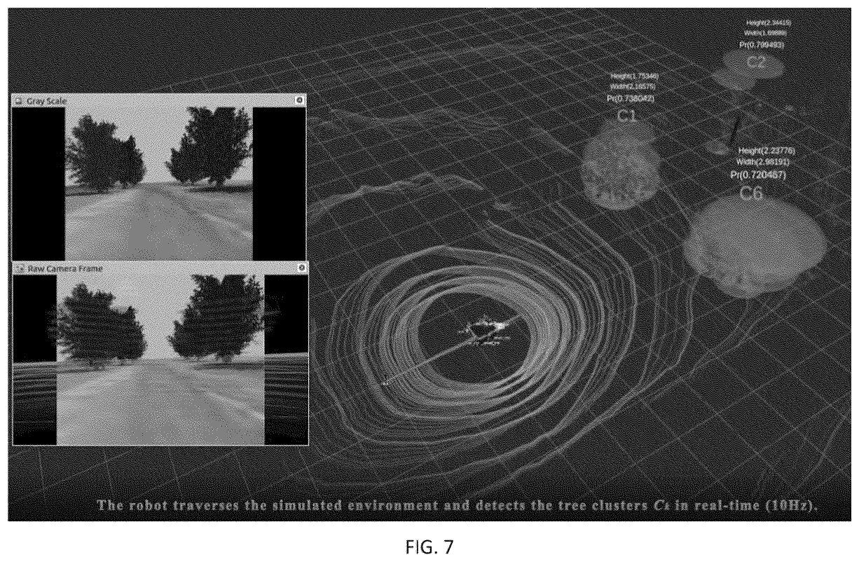

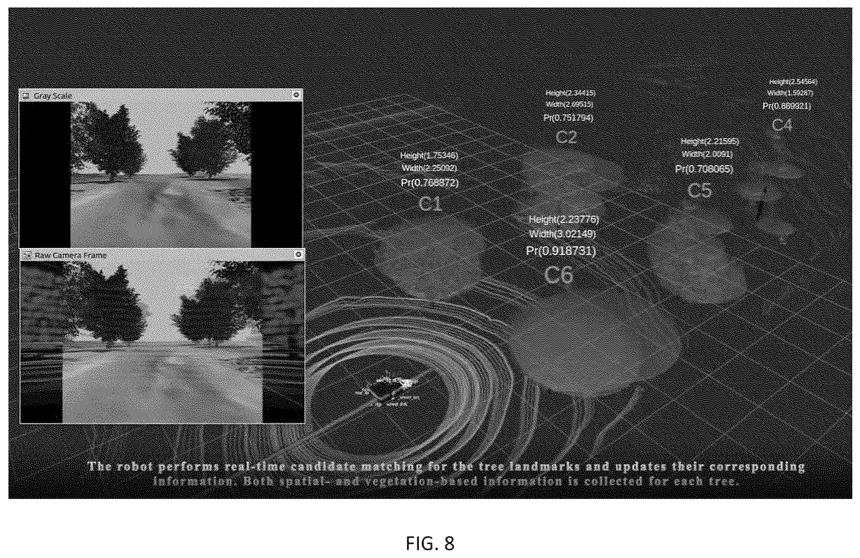

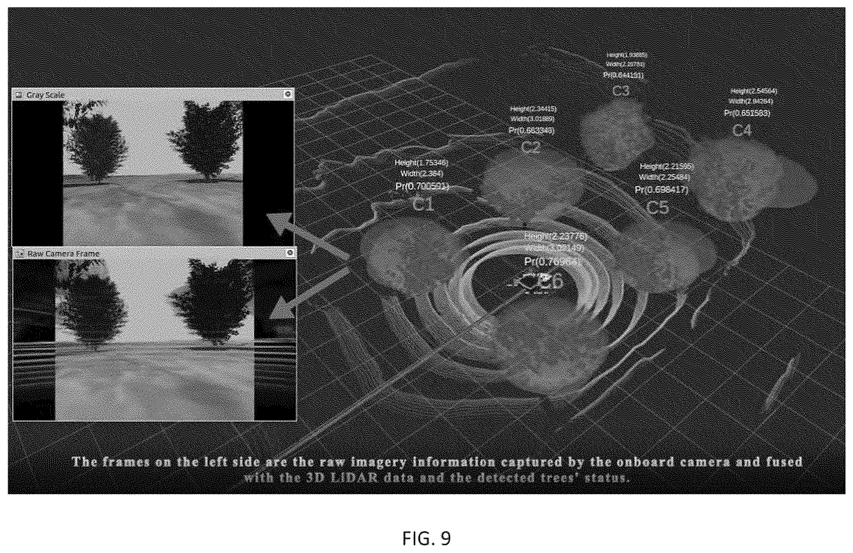

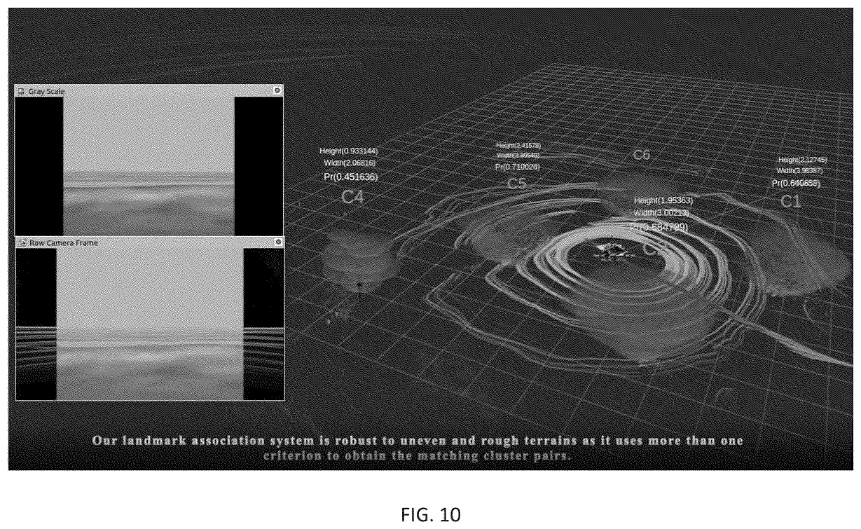

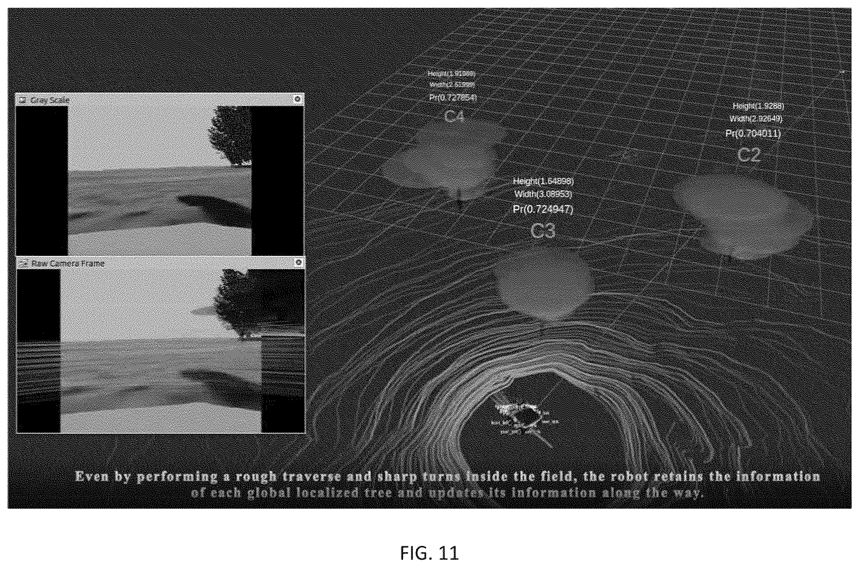

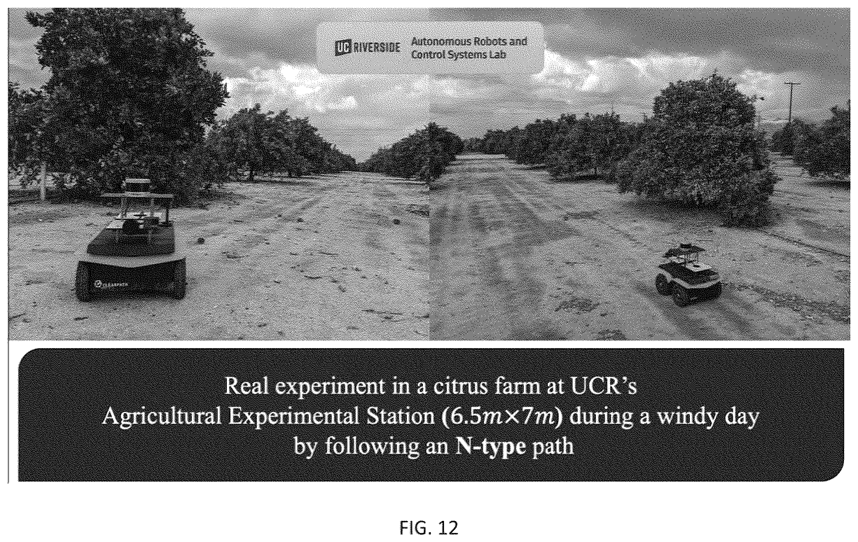

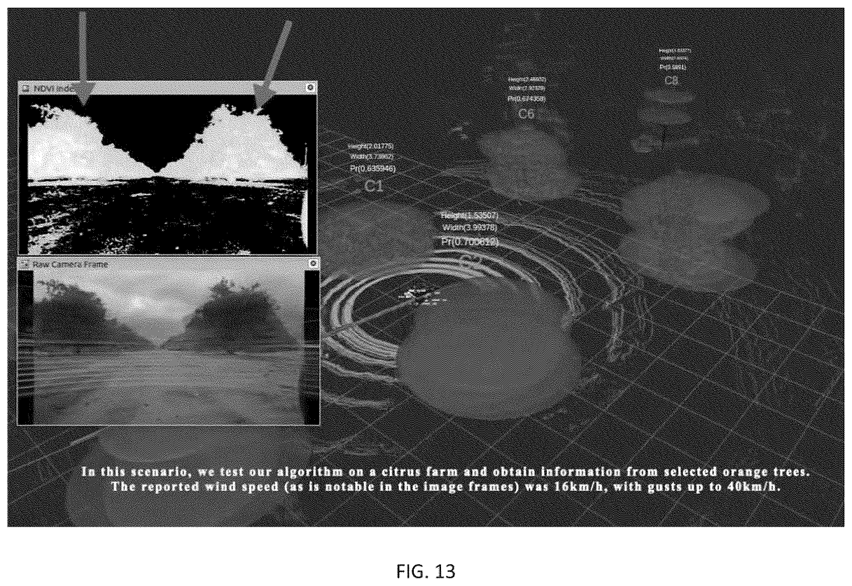

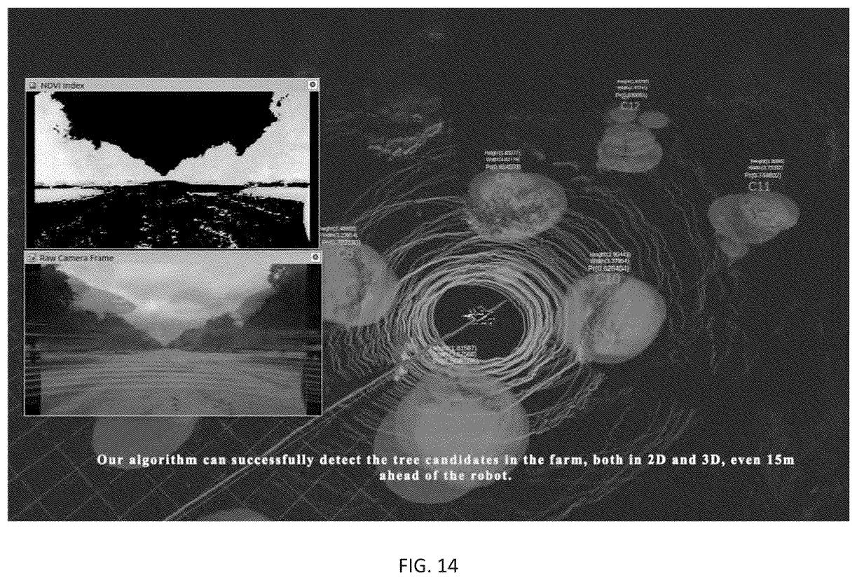

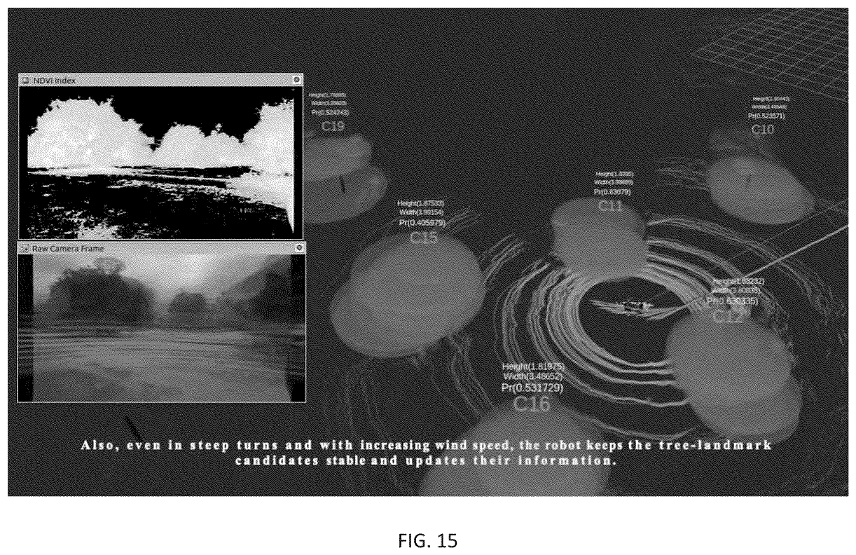

FIGS. 7 through 15 illustrate different aspects of examples of experimental testing involving a mobile robot configured and programmed in accordance with various embodiments of the invention described herein.

From the foregoing, it can be seen that an algorithm has been provided for real-time and on-the-go tree detection and geometric traits estimation with wheeled mobile robots using onboard sensors. The algorithm can use diverse multi-modal sensory data (domain-specific RGN images and 3D point clouds) for tree detection, without relying on any specific tree parts. Part of this process is a multivariate and entropy-based approach, based on an underlying Kalman Filter, which can help to obtain local tree associations, to calculate physical and vegetation-based characteristics, and/or to assign/correlate them with global georeferenced trees for inspection updates. Extensive evaluation in both simulation tests and physical field experiments in an orchard demonstrated the efficacy of the present method and its real-time robustness. The tools and techniques described herein can be extended to multi-robot systems for larger field coverage and can employ multi-modal sensing for in-field and real-time analysis of tree geometry, health, and crop yield indices.

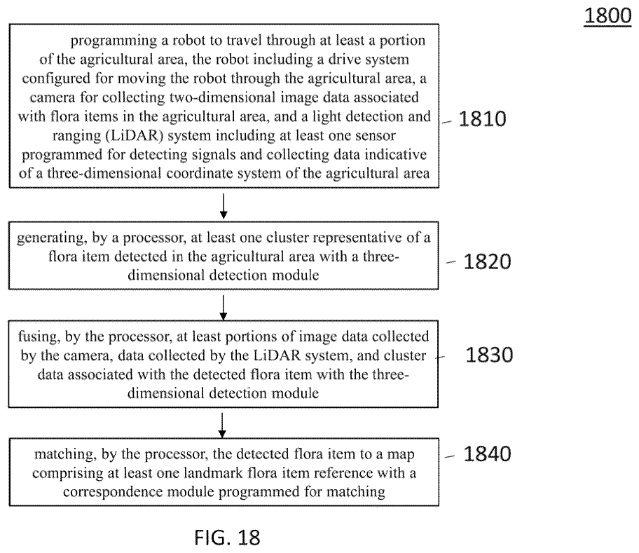

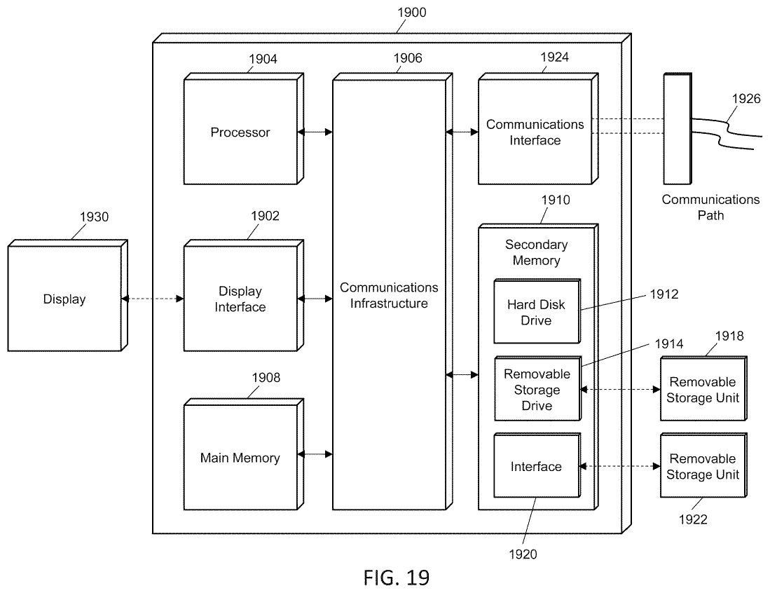

FIG. 18 is a flowchart 1800 of a method for detecting flora in an agricultural area in accordance with an embodiment. The method includes programming a robot to travel through at least a portion of the agricultural area, the robot including a drive system configured for moving the robot through the agricultural area, a camera for collecting two-dimensional image data associated with flora items in the agricultural area, and a light detection and ranging (LiDAR) system including at least one sensor programmed for detecting signals and collecting data indicative of a three-dimensional coordinate system of the agricultural area 1810; generating, by a processor, at least one cluster representative of a flora item detected in the agricultural area with a three-dimensional detection module 1820; fusing, by the processor, at least portions of image data collected by the camera, data collected by the LiDAR system, and cluster data associated with the detected flora item with the three-dimensional detection module 1830; and matching, by the processor, the detected flora item to a map comprising at least one landmark flora item reference with a correspondence module programmed for matching 1840.

FIG. 19 illustrates a representative computer system 1900 in which embodiments of the present disclosure, or portions thereof, may be implemented as computer-readable code executed on hardware. For example, the one or more computer systems associated with the method and system for controlling flammability of a fuel as disclosed herein may be implemented in whole or in part by a computer system 1900 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1918, a removable storage unit 1922, and a hard disk installed in hard disk drive 1912.

A processor device 1904 may be processor device specifically configured to perform the functions discussed herein. The processor device 1904 may be connected to a communications infrastructure 1906, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 1900 may also include a main memory 1908 (e.g., random access memory, read-only memory, etc.), and may also include a secondary memory 1910. The secondary memory 1910 may include the hard disk drive 1912 and a removable storage drive 1914, such as a floppy disk drive, a magnetic tape drive, an optical disk drive, a flash memory, etc.

The removable storage drive 1914 may read from and/or write to the removable storage unit 1918 in a well-known manner. The removable storage unit 1318 may include a removable storage media that may be read by and written to by the removable storage drive 1314. For example, if the removable storage drive 1914 is a floppy disk drive or universal serial bus port, the removable storage unit 1918 may be a floppy disk or portable flash drive, respectively. In one embodiment, the removable storage unit 1918 may be non-transitory computer readable recording media.

In some embodiments, the secondary memory 1910 may include alternative means for allowing computer programs or other instructions to be loaded into the computer system 1900, for example, the removable storage unit 1922 and an interface 1920. Examples of such means may include a program cartridge and cartridge interface (e.g., as found in video game systems), a removable memory chip (e.g., EEPROM, PROM, etc.) and associated socket, and other removable storage units 1922 and interfaces 1920 as will be apparent to persons having skill in the relevant art.

The computer system 1900 may also include a communications interface 1924. The communications interface 1924 may be configured to allow software and data to be transferred between the computer system 1900 and external devices. Exemplary communications interfaces 1924 may include a modem, a network interface (e.g., an Ethernet card), a communications port, a PCMCIA slot and card, etc. Software and data transferred via the communications interface 1924 may be in the form of signals, which may be electronic, electromagnetic, optical, or other signals as will be apparent to persons having skill in the relevant art. The signals may travel via a communications path (or a computer network) 1926, which may be configured to carry the signals and may be implemented using wire, cable, fiber optics, a phone line, a cellular phone link, a radio frequency link, etc.

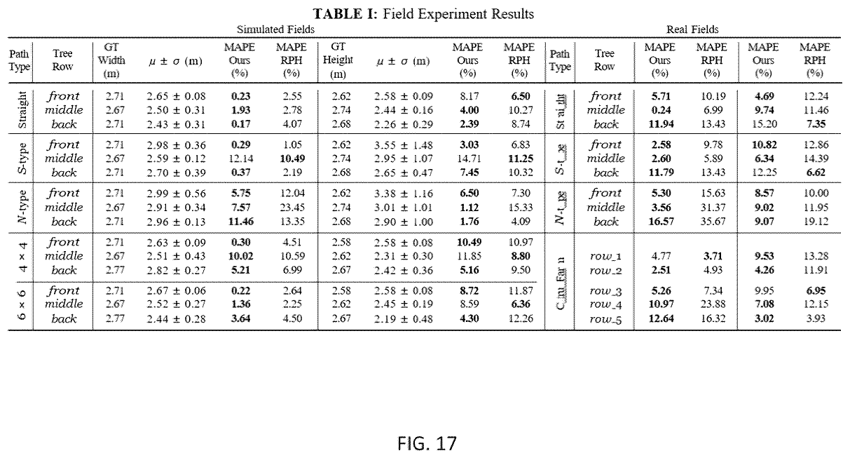

The computer system 1900 may further include a display interface 1902. The display interface 1902 may be configured to allow data to be transferred between the computer system 1900 and external display 1930. Exemplary display interfaces 1902 may include high-definition multimedia interface (HDMI), digital visual interface (DVI), video graphics array (VGA), etc. The display 1930 may be any suitable type of display for displaying data transmitted via the display interface 1902 of the computer system 1900, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 1908 and secondary memory 1910, which may be memory semiconductors (e.g., DRAMs, etc.). These computer program products may be means for providing software to the computer system 1900. Computer programs (e.g., computer control logic) may be stored in the main memory 1908 and/or the secondary memory 1910. Computer programs may also be received via the communications interface 1924. Such computer programs, when executed, may enable computer system 1900 to implement the present methods as discussed herein. In particular, the computer programs, when executed, may enable processor device 1904 to implement the methods illustrated by FIGS. 1(a)-18, as discussed herein. Accordingly, such computer programs may represent controllers of the computer system 1900. Where the present disclosure is implemented using software executed on hardware, the software may be stored in a computer program product and loaded into the computer system 1900 using the removable storage drive 1914, interface 1920, and hard disk drive 1912, or communications interface 1924.

The examples presented herein can be intended to illustrate potential and specific implementations of the present invention. It can be appreciated that the examples can be intended primarily for purposes of illustration of the invention for those skilled in the art. No particular aspect of the examples is necessarily intended to limit the scope of the present invention.

It is to be understood that the figures and descriptions of the present invention have been simplified to illustrate elements that can be relevant for a clear understanding of the present invention, while eliminating, for purposes of clarity, other elements. Those of ordinary skill in the art will recognize, however, that a sufficient understanding of the present invention can be gained by the present disclosure, and therefore, a more detailed description of such elements is not provided herein.

Any element expressed herein as a means for performing a specified function is intended to encompass any way of performing that function including, for example, a combination of elements that performs that function. Furthermore, the invention as may be defined by such means-plus-function claims, resides in the fact that the functionalities provided by the various recited means can be combined and brought together in a manner as defined by the appended claims. Therefore, any means that can provide such functionalities may be considered equivalents to the means shown herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers. Software or other sets of instructions that may be employed to cause programmable equipment to execute the processes may be stored in any storage device, such as a computer system (non-volatile) memory. Furthermore, some of the processes may be programmed when the computer system is manufactured or via a computer-readable memory storage medium.

It can also be appreciated that certain process aspects described herein may be performed using instructions stored on a computer-readable memory medium or media that direct a computer or computer system to perform process steps. A computer-readable medium may include, for example, memory devices such as compact discs of both read-only and read/write varieties, optical disk drives, and hard disk drives. A computer-readable medium may also include memory storage that may be physical, virtual, permanent, temporary, semi-permanent and/or semi-temporary. Memory and/or storage components may be implemented using any computer-readable media capable of storing data such as volatile or non-volatile memory, removable or non-removable memory, erasable or non-erasable memory, writeable or re-writeable memory, and so forth.

Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory, magnetic or optical cards, or any other type of media suitable for storing information.

A “computer,” “computer system,” “computing apparatus,” “component,” or “computer processor” may be, for example and without limitation, a processor, microcomputer, minicomputer, server, mainframe, laptop, smart phone, mobile phone, electronic tablet, cellular phone, processor, or any other programmable device or computer apparatus configured to transmit, process, and/or receive data. Computer systems and computer-based devices disclosed herein may include memory and/or storage components for storing certain software applications used in obtaining, processing, and communicating information. It can be appreciated that such memory may be internal or external with respect to execution of the disclosed embodiments. In various embodiments, a “host,” “engine,” “loader,” “filter,” “platform,” or “component” may include various computers or computer systems, or may include a reasonable combination of software, firmware, and/or hardware. In certain embodiments, a “module” may include software, firmware, hardware, or any reasonable combination thereof.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that can be located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described hereinabove may be implemented in computer software using any suitable computer programming language such as C++ or Python using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, Fortran, Java, Lisp, Pascal, Object Pascal; and examples of scripting languages include Bourne script, JavaScript, Python, R, Ruby, PHP, and Perl. Various embodiments may be employed in a Lotus Notes environment, for example. Such software may be stored on any type of suitable computer-readable medium or media such as, for example, a magnetic or optical storage medium.

Thus, the execution and behavior of the embodiments can be described without specific reference to actual software code. The absence of such specific references is feasible because it is clearly understood that artisans of ordinary skill would be able to design software and control hardware to implement the embodiments of the present invention based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the access device to the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

In various embodiments, a hub may be employed which contains multiple ports. For example, when a data packet arrives at one port of a hub, the packet can be copied unmodified to all ports of the hub for transmission. A network switch or other devices that forward and filter OSI layer 2 datagrams between ports based on MAC addresses in data packets can also be used. A switch can possess multiple ports, such that most of the network is connected directly to the switch, or another switch that is in turn connected to a switch. The term “switch” can also include routers and bridges, as well as other devices that distribute data traffic by application content (e.g., a Web URL identifier). Switches may operate at one or more OSI model layers, including physical, data link, network, or transport (i.e., end-to-end). A device that operates simultaneously at more than one of these layers can be considered a multilayer switch. In certain embodiments, routers or other like networking devices may be used to forward data packets between networks using headers and forwarding tables to determine an optimum path through which to transmit the packets.

As employed herein, an application server may be a server that hosts an API to expose business logic and business processes for use by other applications. Examples of application servers include J2EE or Java EE 5 application servers including WebSphere Application Server. Other examples include WebSphere Application Server Community Edition (IBM), Sybase Enterprise Application Server (Sybase Inc), WebLogic Server (BEA), JBoss (Red Hat), JRun (Adobe Systems), Apache Geronimo (Apache Software Foundation), Oracle OC4J (Oracle Corporation), Sun Java System Application Server (Sun Microsystems), and SAP Netweaver AS (ABAP/Java). Also, application servers may be provided in accordance with the .NET framework, including the Windows Communication Foundation, .NET Remoting, ADO.NET, and ASP.NET among several other components. For example, a Java Server Page (JSP) is a servlet that executes in a web container which is functionally equivalent to CGI scripts. JSPs can be used to create HTML pages by embedding references to the server logic within the page. The application servers may mainly serve web-based applications, while other servers can perform as session initiation protocol servers, for instance, or work with telephony networks. Specifications for enterprise application integration and service-oriented architecture can be designed to connect many different computer network elements. Such specifications include Business Application Programming Interface, Web Services Interoperability, and Java EE Connector Architecture.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to manage simultaneous execution of multiple computer programs.

In various embodiments, the computer systems, data storage media, or modules described herein may be configured and/or programmed to include one or more of the above-described electronic, computer-based elements and components, or computer architecture. In addition, these elements and components may be particularly configured to execute the various rules, algorithms, programs, processes, and method steps described herein.

Various embodiments may be described herein in the general context of computer executable instructions, such as software, program modules, and/or engines being executed by a computer. Generally, software, program modules, and/or engines include any software element arranged to perform particular executions or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where executions can be performed by one or more remote processing devices that can be linked through a communications network. In a distributed computing environment, software, program modules, and/or engines may be located in both local and remote computer storage media including memory storage devices.

Although some embodiments may be illustrated and described as comprising functional components, software, engines, and/or modules performing various executions, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various executions of one or more embodiments. In various embodiments, for example, the article of manufacture may comprise a magnetic disk, optical disk, flash memory or firmware containing computer program instructions suitable for execution by an application specific processor.

Additionally, it is to be appreciated that the embodiments described herein illustrate example implementations, and that the functional elements, logical blocks, modules, and circuits elements may be implemented in various other ways which can be consistent with the described embodiments. Furthermore, the executions performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be conducted in the order of events recited or in any other order which is logically possible.

Reference to “one embodiment” or “an embodiment” means that a particular feature, structure, or characteristic described in connection with the embodiment is comprised in at least one embodiment. The appearances of the phrase “in one embodiment” or “in one aspect” in the specification can be not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

Certain embodiments may be described using the expression “coupled” and “connected” along with their derivatives. These terms can be not necessarily intended as synonyms for each other. For example, some embodiments may be described using the terms “connected” and/or “coupled” to indicate that two or more elements can be in direct physical or electrical contact with each other. The term “coupled,” however, also may mean that two or more elements can be not in direct contact with each other, but still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and can be comprised within the scope thereof. Furthermore, all examples and conditional language recited herein can be principally intended to aid the reader in understanding the principles described in the present disclosure and the concepts contributed to furthering the art, and can be construed as being without limitation to such specifically recited examples and conditions. Moreover, all statements herein reciting principles, aspects, and embodiments as well as specific examples thereof, can be intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein.

Although various systems described herein may be embodied in software or code executed by general purpose hardware as discussed above, as an alternative the same may also be embodied in dedicated hardware or a combination of software, hardware and/or dedicated hardware. If embodied in dedicated hardware, each can be implemented as a circuit or state machine that employs any one of or a combination of a number of technologies. These technologies may include, but can be not limited to, discrete logic circuits having logic gates for implementing various logic functions upon an application of one or more data signals, application specific integrated circuits having appropriate logic gates, or other components, etc. Such technologies can be generally well known by those of ordinary skill in the art and, consequently, might not be described in detail herein.

The flow charts and methods described herein show the functionality and execution of various implementations. If embodied in software, each block, step, or action may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s). Although the flow charts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be omitted or not performed. It is understood that all such variations can be within the scope of the present disclosure.

The terms “a” and “an” and “the” and similar referents used in the context of the present disclosure (especially in the context of the following claims) can be to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as though it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein can be not to be construed as limitations. Each group member may be referred to and claimed individually or in any combination with other members of the group or other elements found herein. It is anticipated that one or more members of a group may be comprised in, or deleted from, a group for reasons of convenience and/or patentability.

In various embodiments of the present invention, different types of artificial intelligence tools and techniques can be incorporated and implemented. Search and optimization tools including search algorithms, mathematical optimization, and evolutionary computation methods can be used for intelligent searching through many possible solutions. For example, logical operations can involve searching for a path that leads from premises to conclusions, where each step is the application of an inference rule. Planning algorithms can search through trees of goals and subgoals, attempting to find a path to a target goal, in a process called means-ends analysis.

Heuristics can be used to prioritize choices in favor of those more likely to reach a goal and to do so in a shorter number of steps. In some search methodologies heuristics can also serve to eliminate some choices unlikely to lead to a goal. Heuristics can supply a computer system with a best estimate for the path on which the solution lies. Heuristics can limit the search for solutions into a smaller sample size, thereby increasing overall computer system processing efficiency.

Propositional logic can be used which involves truth functions such as “or” and “not” search terms, and first-order logic can add quantifiers and predicates, and can express facts about objects, their properties, and their relationships with each other. Fuzzy logic assigns a degree of truth (e.g., between 0 and 1) to vague statements which may be too linguistically imprecise to be completely true or false. Default logics, non-monotonic logics and circumscription are forms of logic designed to help with default reasoning and the qualification problem. Several extensions of logic can be used to address specific domains of knowledge, such as description logics, situation calculus, event calculus and fluent calculus (for representing events and time), causal calculus, belief calculus (belief revision); and modal logics. Logic for modeling contradictory or inconsistent statements arising in multi-agent systems can also be used, such as paraconsistent logics.

Probabilistic methods can be applied for uncertain reasoning, such as Bayesian networks, hidden Markov models, Kalman filters, particle filters, decision theory, and utility theory. These tools and techniques help the system execute algorithms with incomplete or uncertain information. Bayesian networks are tools that can be used for various problems: reasoning (using the Bayesian inference algorithm), learning (using the expectation-maximization algorithm), planning (using decision networks), and perception (using dynamic Bayesian networks). Probabilistic algorithms can be used for filtering, prediction, smoothing and finding explanations for streams of data, helping perception systems to analyze processes that occur over time (e.g., hidden Markov models or Kalman filters). Artificial intelligence can use the concept of utility as a measure of how valuable something is to an intelligent agent. Mathematical tools can analyze how an agent can make choices and plan, using decision theory, decision analysis, and information value theory. These tools include models such as Markov decision processes, dynamic decision networks, game theory and mechanism design.

The artificial intelligence techniques applied to embodiments of the invention may leverage classifiers and controllers. Classifiers are functions that use pattern matching to determine a closest match. They can be tuned according to examples known as observations or patterns. In supervised learning, each pattern belongs to a certain predefined class which represents a decision to be made. All of the observations combined with their class labels are known as a data set. When a new observation is received, that observation is classified based on previous experience. A classifier can be trained in various ways; there are many statistical and machine learning approaches. The decision tree is one kind of symbolic machine learning algorithm. The naive Bayes classifier is one kind of classifier useful for its scalability, in particular. Neural networks can also be used for classification. Classifier performance depends in part on the characteristics of the data to be classified, such as the data set size, distribution of samples across classes, dimensionality, and the level of noise. Model-based classifiers perform optimally when the assumed model is an optimized fit for the actual data. Otherwise, if no matching model is available, and if accuracy (rather than speed or scalability) is a primary concern, then discriminative classifiers (e.g., SVM) can be used to enhance accuracy.

A neural network is an interconnected group of nodes which can be used in connection with various embodiments of the invention, such as execution of various methods, processes, or algorithms disclosed herein. Each neuron of the neural network can accept inputs from other neurons, each of which when activated casts a weighted vote for or against whether the first neuron should activate. Learning achieved by the network involves using an algorithm to adjust these weights based on the training data. For example, one algorithm increases the weight between two connected neurons when the activation of one triggers the successful activation of another. Neurons have a continuous spectrum of activation, and neurons can process inputs in a non-linear way rather than weighing straightforward votes. Neural networks can model complex relationships between inputs and outputs or find patterns in data. They can learn continuous functions and even digital logical operations. Neural networks can be viewed as a type of mathematical optimization which performs a gradient descent on a multi-dimensional topology that was created by training the network. Another type of algorithm is a backpropagation algorithm. Other examples of learning techniques for neural networks include Hebbian learning, group method of data handling (GMDH), or competitive learning. The main categories of networks are acyclic or feedforward neural networks (where the signal passes in only one direction), and recurrent neural networks (which allow feedback and short-term memories of previous input events). Examples of feedforward networks include perceptrons, multi-layer perceptrons, and radial basis networks.

Deep learning techniques applied to various embodiments of the invention can use several layers of neurons between the network's inputs and outputs. The multiple layers can progressively extract higher-level features from the raw input. For example, in image processing, lower layers may identify edges, while higher layers may identify the concepts relevant to a human such as digits, letters, or faces. Deep learning may involve convolutional neural networks for many or all of its layers. In a convolutional layer, each neuron receives input from only a restricted area of the previous layer called the neuron's receptive field. This can substantially reduce the number of weighted connections between neurons. In a recurrent neural network, the signal will propagate through a layer more than once. A recurrent neural network (RNN) is another example of a deep learning technique which can be trained by gradient descent, for example.

According to various embodiments, a single component may be replaced by multiple components, and multiple components may be replaced by a single component, to perform a given function or functions.

Any patent, publication, or other disclosure material, in whole or in part, which is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While various embodiments of the invention have been described herein, it should be apparent, however, that various modifications, alterations, and adaptations to those embodiments may occur to persons skilled in the art with the attainment of some or all of the advantages of the present invention. The disclosed embodiments can be therefore intended to include all such modifications, alterations, and adaptations without departing from the scope and spirit of the present invention as described and claimed herein.

What is claimed is:

1. A robot programmed to travel through at least a portion of an agricultural area, the robot comprising:
a drive system configured for moving the robot through the agricultural area;
a camera for collecting two-dimensional image data associated with flora items in the agricultural area;
a light detection and ranging (LiDAR) system comprising at least one sensor programmed for detecting signals and collecting data indicative of a three-dimensional coordinate system of the agricultural area;
a computer processor programmed for executing multiple computer-implemented modules of the robot;
a three-dimensional detection module programmed for:
generating, by the processor, at least one cluster representative of a flora item detected in the agricultural area, and
fusing, by the processor, at least portions of image data collected by the camera, data collected by the LiDAR system, and cluster data associated with the detected flora item; and
a correspondence module programmed for matching, by the processor, the detected flora item to a map comprising at least one landmark flora item reference.

2. The robot of claim 1, further comprising the three-dimensional detection module programmed with multi-variate criteria for processing cluster matching.

3. The robot of claim 1, further comprising a flora characteristic module programmed for determining characteristic data associated with at least one detected flora item.

4. The robot of claim 3, further comprising the flora characteristic module being programmed for determining at least one spatial-based characteristic for the detected flora item.

5. The robot of claim 4, wherein the spatial-based characteristic comprises a height dimension of the detected flora item.

6. The robot of claim 4, wherein the spatial-based characteristic comprises a width dimension of the detected flora item.

7. The robot of claim 3, further comprising the flora characteristic module being programmed for determining at least one vegetation-based characteristic for the detected flora item.

8. The robot of claim 7, further comprising the flora characteristic module being programmed for determining a Normalized Difference Vegetation Index (NDVI) for the detected flora item.

9. The robot of claim 8, wherein the NDVI defines a ratio between near-infrared radiation (NIR) reflected by the detected flora item and red light absorbed by the detected flora item.

10. The robot of claim 1, further comprising an update module programmed for updating, by the processor, data regarding at least one detected flora item in real-time as the robot travels through the agricultural area.

11. The robot of claim 1, wherein the robot is configured to travel semi-autonomously through the agricultural area.

12. The robot of claim 1, wherein the robot is configured to travel autonomously through the agricultural area.

13. The robot of claim 1, wherein the agricultural area comprises at least one of a field, a farm, and/or an orchard, and at least one flora item comprises a tree.

14. A method for detecting flora in an agricultural area, the method comprising:
programming a robot to travel through at least a portion of the agricultural area, the robot including a drive system configured for moving the robot through the agricultural area, a camera for collecting two-dimensional image data associated with flora items in the agricultural area, and a light detection and ranging (LiDAR) system including at least one sensor programmed for detecting signals and collecting data indicative of a three-dimensional coordinate system of the agricultural area;
generating, by a processor, at least one cluster representative of a flora item detected in the agricultural area with a three-dimensional detection module;
fusing, by the processor, at least portions of image data collected by the camera, data collected by the LiDAR system, and cluster data associated with the detected flora item with the three-dimensional detection module; and
matching, by the processor, the detected flora item to a map comprising at least one landmark flora item reference with a correspondence module programmed for matching.

15. The method of claim 14, further comprising:
determining characteristic data associated with at least one detected flora item with a flora characteristic module; and
determining at least one spatial-based characteristic for the detected flora item with flora characteristic module.

16. The method of claim 15, wherein the spatial-based characteristic comprises one or more of a height dimension of the detected flora item and a width dimension of the detected flora item.

17. The method of claim 15, further comprising:
determining at least one vegetation-based characteristic for the detected flora item with the flora characteristic module; and
determining a Normalized Difference Vegetation Index (NDVI) for the detected flora item with the flora characteristic module.

18. The method of claim 17, wherein the NDVI defines a ratio between near-infrared radiation (NIR) reflected by the detected flora item and red light absorbed by the detected flora item.

19. The method of claim 14, further comprising an update module programmed for updating, by the processor, data regarding at least one detected flora item in real-time as the robot travels through the agricultural area.

20. The method of claim 14, wherein the agricultural area comprises at least one of a field, a farm, and/or an orchard, and at least one flora item comprises a tree.
